(19) United States
(12) Patent Application Publication
(10) Pub. No.: US 2009/0018967 A1
(43) Pub. Date: Jan. 15, 2009

(54) COMPUTER-BASED METHOD TO GRADE AND RANK ENTITIES

(76) Inventors: Michel L. Balinski, Paris (FR); Mohammed Rida Laraki, Paris (FR)

Correspondence Address: O''BRIEN JONES, PLLC, 8200 Greensboro Drive, Suite 1020A, McLean, VA, 22102, US

(21) Appl. No.: 11/777,058

(22) Filed: Jul. 12, 2007

(51) Int. Cl. G06F 7/08; G06F 17/30; G06F 7/72; G06Q 40/00; G06Q 50/00

(52) U.S. Cl. 705/36 R; 707/7; 708/208; 707/E17.002

(57) ABSTRACT

A computer implemented method for at least one of grading, measuring, classifying entities and/or ranking entities, and/or designating a winner among entities, with each entity assigned n grades of an ordered language of evaluation, where n is an integer greater than 1, may comprise sorting the grades assigned each entity according to a first ordering rule to obtain a first list of ordered grades. For i=1, . . . , n, generating for each entity a second list of ordered grades from the first list by assigning all i^{th} grade of the first list to a place in the second list according to a second ordering rule, and at least one of assigning a first grade of an entity's second list to that entity, ranking the entities based on comparisons of the second lists, designating the winner among the entities as the one that is the first in the ranking, and classifying the entities based on the second lists.

### FIELD OF THE INVENTION

The present invention relates to a computer implemented method for at least one of grading, measuring, classifying and/or ranking entities and to a computer system for performing such a method.

### BACKGROUND

Competitions are as old as the hills. The winners and rankings among entities in some—for example, running, high-jumping or javelin throwing—are clear: measures of time, height or length determine them. The winners and rankings among entities in many areas, however, depend on factors that are not unambiguously measurable. Examples abound.
Sports competitions: figure skaters, gymnasts, divers, ski jumpers, . . .
Competitions among products: wines, cheeses, paintings, new technological creations, posters, advertising campaigns, . . .
Competitions among musicians: pianists, flutists, orchestras, . . .
Rating services: restaurants, hotels, employees, . . .
Rating entertainment: films, theatrical performances, beauty contests, . . .
Elections: public offices, officers of professional societies, officers of clubs, . . .
Prize competitions: Nobel prizes, theatrical prizes, movie prizes, Oscars, literary and scientific prizes, Pulitzer's, . . .
Classifying miscellaneous “objects” that may be of interest: schools, universities, cities, hospitals, . . .
Evaluating, classifying and rating investments, and risky assets, . . .
Evaluating, classifying and comparing sets of physical measurements such as blood pressure, temperature, distance, weight, molecules, . . .

In these, and many other instances, the winner and the ranking among the entities are determined by several judges, expert jury members, committee members, an electorate, or repeated measurements with one or several instruments.

There are very many different mechanisms by which the evaluations of the judges, jury or committee members, voters or measurements are amalgamated into a decision that designates the winner and the order of finish.

Mathematicians, economists and political scientists have extensively studied methods of aggregating preferences, in particular voting, concluding that there is no good method (Kenneth Arrow's celebrated “impossibility theorem” and its many derivatives and generalizations). On the other hand, the procedures used to amalgamate the evaluations of judges and jury or committee members in many practical situations are ad hoc, invented by those who need them—the musicians, sports associations, politicians or medical doctors. Typically, their conceivers have no expertise for understanding the implications of using one or another procedure, and they almost always use ones that yield very, questionable results and eventually, acrimony and dispute.

### EXAMPLE 1

Figure Skating. The big scandal of the 2002 winter Olympic games held in Salt Lake City concerned the first two finishers in the pairs figure skating competition. A judge confessed to have yielded to pressure and unduly favored (though she later denied it) the Russian pair (that finished first) over the Canadian pair (that finished second), causing the International Skating Union (ISU) to change the outcome to a first place tie, so two gold medals. This shows that judges could exaggerate or manipulate their evaluations and thereby effect the result with the procedure then in use. That procedure had other serious drawbacks including one that bewildered the public: the rankings of the skaters were naturally updated after each individual performance; often the order between two skaters “flip-flopped”—that is, was reversed—solely as the result of a third skater's performance (“Arrow's paradox”)!

The 2002 scandal provoked a huge debate, and led to the adoption of a new, very complex system (used for figure skating competitions among men, among women, and among pairs). As in the past, there are two performances, the short program and the free skating program. An “executed element” of both is a part of a program (e.g., a “layback spin level 3,” a “death spiral,” a “triple-flip,” or combinations of them). Each executed element has a “base value” of points that are previously determined by a technical committee. A skater's program is formally announced as a collection of executed elements (about eight for the short program, about fourteen for the long program). A judge gives to each executed element of a skater a merit or demerit of 0, ±1, ±2, or ±3. They modify the base values in those amounts and determine the skater's executed elements scores given by each of the judges. A judge also gives grades to each of five “program components” (skating skills, transition/linking footwork, performance/execution, choreography/composition, interpretation) on a scale of 0 to 10 in increments of 0.25. Each of the program components are multiplied by a factor of 1 in the short program and a factor of 2 in the free skating program and gives the skater's program components scores.

There are twelve judges, thus the input of the procedure for each skater is two tables of scores: (1) the executed element table, one line for each executed element, one column for each judge; and (2) the program component table, one line for each component, one column for each judge. The tables are known to everyone, but the judges are not identified. The system selects three judges at random and ignores their scores (which three judges is not announced), giving two tables of nine columns (corresponding to nine judges). In each row (of each table) the highest and lowest score is eliminated, and the average of the seven remaining scores calculated. Their sum determines the skater's total score. The skaters are ranked according to their total scores.

This procedure has been severely criticized by figure skating professionals for a host of reasons (in fact, a rival to the ISU called the World Skating Federation was created with the avowed intent of keeping the old method, but failed). First, they find it difficult to accept the idea that the quality of an entire performance is merely equal to a sum of its parts. Second, the elimination of scores of three judges chosen at random and then of the highest and lowest scores of each executed element and each program component score is meant to combat the impact of exaggerated scores or outright cheating. It reduces the impact, but certainly does not eliminate it as much as it can be: moreover, it discards useful information and ends with questionable results.

There are 220 ways of eliminating three judges, so the procedure ends up with one of 220 different possible “panels” that decides the outcome. Anyone can calculate the 220 possible outcomes. Used to rank the top three women figure skaters in the short program of the 2006 Olympics, 67 panels agree with the official result, 153 do not; 92 agree on first-place, 128 do not: a completely random choice effectively determined the winner and the ranking. That is outrageous!

### EXAMPLE 2

Gymnastics. The ISU's procedure was directly inspired by the method used by the International Gymnastics Federation (IGF): it provoked the major scandal of the 2004 Olympic summer games held in Athens, Greece. An American was awarded the men's all around gold medal, but had the correct base value (called the “start value” in the gymnast's system) been given to a Korean competitor for his routine on the parallel bars, then, ceteris paribus, the Korean would have won the gold medal. There was no dispute over the fact that the error had been made. It was caused by the pressure placed on judges to assign evaluations to many individual elements in short periods of time. After many disputes and an IGF request that the American relinquish the gold medal, refused by the gold medal winner, the Korean Olympic Committee demanded a hearing at the Court of Arbitration for Sport. The initial decision was finally confirmed, but a sense of inequity remained.

A major defect of the procedures used in gymnastics and in skating is the obligation of judges to evaluate many separate parts of a performance in short time intervals.

### EXAMPLE 3

Diving. The method used by the Féderation Internationale de Natation (FINA) is relatively straightforward. Each dive has a degree of difficulty computed by adding five factors. Judges give scores on a scale of 0 to 10: completely failed, 0; unsatisfactory, ½ to 2; deficient, 2½ to 4½; satisfactory, 5 to 6; good, 6½ to 8; and very good, 8½ to 10. There are five or seven judges. If five, the highest and lowest scores are eliminated, if seven, the two highest and two lowest scores are eliminated. The sum of the remaining scores is multiplied by the degree of difficulty to obtain the score of the dive. As in skating, the elimination of highest and lowest scores combats but does not eliminate exaggeration or cheating as much as is possible.

### EXAMPLE 4

Musicians. Many different methods are used. Some are not explicitly known: sometimes “internal regulations” are referred to, in several cases, a “proprietary computer program” is cited. But in these and most instances, judges assign numerical scores—ranging from 0 to 12, to 15, to 25 or sometimes other numbers (and sometimes “adjusted” statistically)—and the order of their sums determines the winner and the ranking. The methods are wide open to exaggeration and cheating.

### EXAMPLE 5

Wines. Different methods are used throughout the world, though the Union Internationale des (Enologues (U.I.(E.)—a federation of national oenological associations—proposes a standard method. It asks each judge to assign a grade of excellent, veal good, good, passable, inadequate, mediocre, or bad to each of 14 attributes of a wine: 3 for “aspect,” limpidity, nuance and intensity; 4 for “aroma,” frankness, intensity, finesse, and harmony; 6 for “taste and flavour,” frankness, intensity, body, harmony, persistence, and after-taste; and 1 global opinion. To each of the assignments of a grade is associated a number attribute score going from either 6 or 8 for excellent down to 0 for bad. Their sum (between 0 and 100) determines the score given to the wine by the judge. The jury's score is the average of the scores given by its members. The jury's score determines by pre-established regulations if a wine is to be classified as a gold, silver, or bronze medallist, or is to receive no medal.

It is widely recognized that the sum misses the point altogether because it “has difficulty in detecting exceptional wines by overly favoring those that are ‘taste-wise correct’” (see, E. Peynaud and J. Blouin, Découvrir le gout du vin, Dunod, Paris, p. 109.). Also, there is strong evidence showing that expert judges work “backwards,” they first decide the score they wish to bestow, then assign attribute scores whose sum is what they wished. Moreover, taking the average of the judge's scores implies that those who give the most extreme grades (high or low) have the greatest impact on the jury's score. For example, the director of an Australian wine competition complained that the score of one judge could bar a wine from being given a gold medal even when a majority of the jury believed it should be awarded a gold medal.

### EXAMPLE 6

Elections: practice. When, in the United States, England and France (as well as many other nations), one candidate among several is to be chosen, each voter casts one vote for at most one candidate, and the candidate with the most votes is elected (in France, if no candidate has an absolute majority, a run-off election is held between the two candidates having the most votes). This method may yield very questionable results whenever there are at least three candidates, as many instances in history testify.

A particularly telling example is the 2002 French presidential election. There were 16 candidates. Chirac, of the right (19.9% of the vote), and Le Pen, of the far right (16.9%), had the most votes, so faced each other in a second round: Chirac won with a huge majority (over 80%). Had an erstwhile socialist Chévènement (5.3%) not been a candidate, the socialist Jospin (16.2%) would certainly have taken most of his votes, and the second round would have been what France had expected, a runoff between Chirac (the then president) and Jospin (the then prime-minister). Polls suggested Jospin would have won. Pasqua, an old ally of Chirac, had announced his candidacy then withdrew; Taubira, closely linked to the socialists had suggested she might withdraw but did not. Had both done otherwise, most of Taubira's votes (2.39/4) would have gone to Jospin, and Pasqua might well have attracted some 3.5% of the votes away from Chirac: the second round would then have seen a race between Jospin and Le Pen!

The example shows that the outcome of an election among “major” candidates depends on “minor” candidacies, persons who have no chance whatsoever of being elected. This is “Arrow's paradox”: the dependence of the outcome on irrelevant alternatives. The same type of phenomena have occurred in US history when there were more than two candidates for president or for the Senate.

### EXAMPLE 7

Elections: theory. A scientific theory of amalgamating preferences or opinions, or of voting, “social choice theory,” has been elaborated in the last several centuries. It has devoted its attentions on how to elect and to rank mainly to elections, taking for its central paradigm that each judge or voter has a list of preferences among the candidates. The major conclusion that dominates this theory is the impossibility theorem of Kenneth Arrow: it shows there can be no reasonable procedure for amalgamating preferences or for voting. The paradigm is much too restrictive. This no doubt explains why so man-y different procedures are used throughout the world.

### SUMMARY

There exists a need for a method and computer system for resolving at least some of the practical difficulties that have been discussed above.

An object of the present invention is to provide a computer implemented method for at least one of grading, measuring and classifying entities and/or ranking entities and/or designating a winner among entities, with each entity assigned n grades of an ordered language of evaluation, where n is an integer greater than 1, the method comprising:

a) sorting the grades assigned each entity according to a first ordering rule to obtain a first list of ordered grades,

b) generating for each entity a second list of ordered grades from the first list by assigning an i^{th} grade of the first list for i=1, . . . , n to a place in the second list according to a second ordering rule,

c) at least one of assigning a first grade of an entity's second list to that entity, ranking the entities based on comparisons of the second lists, designating the winner among the entities as the one that is the first in the ranking, and classifying the entities based on the second lists.

The number n of grades may be the same for all entities or the entities may have at least initially different numbers of grades, n being different for at least two entities.

The entities may be selected among persons, objects, for example wines, services, institutions, companies or legal entities, investment portfolios and measurements, for example physical or chemical measurements.

The grades may be assigned by persons, for example judges, committee members, electors, or instruments, for example sensors.

The grades may depend on the ordered language of evaluation and may be numerical values or non-numerical ordered attributes, for example letters, words or phrases.

The method may comprise the selection of the ordered language of evaluation among various predefined languages. The selection may be performed by prompting a user to select the language.

The first ordering rule may list the grades from highest to lowest or in a variant embodiment from lowest to highest.

In exemplary embodiments, for a given parameter q from 0 to less than 1, the second ordering rule may comprise:

a) initializing a first current ordered list as the first list of ordered grades,

b) for i=1, . . . , n the i^{th} grade of the second list is the k^{th} grade of the i^{th} current ordered list, where k=[q(n−i+1)]+1, and the (i+1)^{th} current ordered list is obtained from the i^{th} ordered current list by dropping the i^{th} grade just designated. [x] means the integer part of x.

In an exemplar, embodiment, q=0.5 and the first ordering rule lists the grades from highest to lowest.

The comparisons of the second lists may be lexicographic.

In an exemplary embodiment, when the entities have initially different numbers of grades, the entities that do not have as many grades as the other may be assigned supplementary grades as many times as necessary so that all the entities have the same number of grades.

In an exemplary embodiment, when the entities have initially different numbers of grades, the first grade of the second list of each entity that does not have as many grades as the other may be adjoined as many times as necessary to that second list so that all the entities have the same number of grades in their second lists, the adjoined grades being either all adjoined at the beginning of the second list or all adjoined at the end of the second list.

In exemplary embodiments, with each entity evaluated by a set of characteristics, each characteristic of each entity assigned characteristic grades, a rule may assign an entity's grade to any set of the entity's characteristic grades, and the method defined above may be applied to the entity's grades.

In exemplary embodiments, with each entity evaluated by a set of characteristics, each characteristic of each entity assigned characteristic grades, the method defined above may be used to obtain a second list of characteristic grades for each characteristic of each entity, and the i^{th} grade of the second list of grades of each entity may be obtained with a rule that assigns a grade to the set of the entity's second list of i^{th} characteristic grades.

The present invention further provides a computer implemented method for either grading entities and/or ranking entities and/or classifying entities and/or designating a winner among entities, with each entity assigned many grades of an ordered language of evaluations, the method comprising:

a) determining percentages of the different grades assigned to each entity,

b) determining, for any q between 0 and 1, for example 0.5, a qualified-majority-grade g of each entity, namely, g such that at least 100 q % of the entity's grades is g or higher,

c) ranking the entities and/or designating the winner as the first in the ranking.

The ranking may be performed according to the following rule: an entity with a higher qualified-majority-grade g than another is ranked higher. Otherwise, a tie-breaking rule may be used.

In a variant the step b) above may be replaced by:

b) determining, for any q between 0 and 1, for example 0.5, a qualified-majority-grade g of each entity, namely, g such that at least 100(1−q) % of the entity's grades is g or lower.

In exemplary embodiments, ties in the ranking of entities may be resolved by determining p⁺(g), i.e. the percentage of an entity's grades higher than g and p⁻(g) i.e. the percentage of the entity's grades lower than g, and the ranking a of two entities with an equal qualified-majority-grade g may be resolved by ranking higher the entity for which (1−q)p⁺(g)−qp⁻(g) is bigger. Further ties may be resolved by their rules.

In exemplary embodiments, ties in the ranking of entities may be resolved by determining p⁺(g) i.e. the percentage of the enity's grades higher than g and p⁻(g), i.e. the percentage of the entity's grades lover than g and by:
assigning the entity a modified-majority-grade g⁺ if (1−q)p⁺(g)>qp⁻(g),
assigning the entity a modified-majority-grade g⁻ if (1−q)p⁺(g)<qp⁻(g),
ranking higher an entity with a modified-majority-grade of g⁺ than one with a modified-majority-grade of g⁻,
between two entities with a modified-majority-grade of g⁺, ranking higher the entity with the greater p⁺(g),
between two entities with a modified-majority-grade of g⁻, ranking lower the entity with the greater p⁻(g),
using otherwise a further tie-breaking rule, if applicable.

In exemplary embodiments, ties in the ranking of entities may be resolved according to the rule:
assign the entity a modified-majority-grade g⁼ if (1−q)p⁺(g)=qp⁻(g),
an entity with a modified-majority-grade of g⁺ is ranked higher than one with a modified-majority-grade of g⁼,
an entity with a modified-majority-grade of g⁼ is ranked higher than one with a modified-majority-grade of g⁻,
between two entities with a modified-majority-grade of g⁻ and the same p⁻(g), the entity with the smaller p⁺(g) is ranked higher,
between two entities with a modified-majority-grade of g⁻ and the same p⁻(g), the entity with the greater p⁺(g) is ranked higher,
otherwise, a tie-breaking rule may be used.

In an exemplary embodiment, when the entities have initially different numbers of grades, those that do not have the greatest number of grades may be assigned supplementary grades as many times as necessary so that all the entities have the same number of grades.

A further object of the present invention is a computer system configured for performing any method defined above.

The computer system may comprise processor means configured for:

a) sorting the grades assigned each entity according to a first ordering rule to obtain a first list of ordered grades,

b) generating for each entity a second list of ordered grades from the first list by assigning an i^{th} grade of the first list for i=1 . . . , n to a place in the second list according to a second ordering rule,

c) displaying a result, the result comprising at least one of assigning a first grade of an entity's second list to that entity, ranking the entities based on comparisons of the second lists, designating the winner among the entities as the one that is the first in the ranking, and classifying the entities based on the second lists.

The result may be displayed in various mariners, for example at least one of displayed on a screen, printed, voice synthesized or broadcasted through a computer network or media network.

A further object of the present invention is a computer program comprising instructions readable by a computer system and configured for causing the computer system to perform the various steps of any method defined above.

### BRIEF DESCRIPTION OF THE DRAWINGS

It is to be understood that both the foregoing general description and the following detailed description are explanatory and explanatory only and are not restrictive of the invention.

The accompanying drawings, which are incorporated in and constitute a part of this specification, illustrate several exemplary embodiments of the invention and together with the description, seine to explain principles of the invention.

FIG. 1 illustrates an exemplary, flowchart of a method consistent with features and principles of the present invention, detailing inputs, processing of the inputs and outputs when there is one global criterion.

FIG. 2 illustrates an exemplary flowchart of a method consistent with features and principles of the present invention detailing inputs, two alternate manners of processing of the inputs, i.e. a “characteristics based” procedure and an “entity based” procedure and outputs, when more than one criterion is used in the evaluations of the entities,

FIG. 3 illustrates an exemplary flowchart of a method consistent with features and principles of the present invention detailing inputs, processing of the inputs and outputs of a simplified procedure that may be used in any circumstance but may be more adequate for problems when there are many judges (e.g., hundreds to millions) and a language of evaluation that is relatively small (e.g., less than twenty words).

### DETAILED DESCRIPTION OF VARIOUS EXEMPLARY EMBODIMENTS OF THE INVENTION

A method consistent with features and principles of the present invention is performed at least partially using a computer system.

The computer system may comprise any computer, for example any personal computer for example a home computer, a laptop, a PDA, a mobile phone, a processor of a medical or scientific instrument, or a more powerful computer system, for example a super computer.

The method may be performed wholly by a single computer or may be performed using an exchange of data through a network, for example an Ethernet network, an Internet Protocol Network, a telephone network or any mechanism permitting communication between two or more nodes or remote locations.

The computer system may comprise processor means such as software and hardware residing at a single location or at many different locations.

The computer system may comprise a user interface for entry of various inputs of the method, for example possibly selecting a language for evaluation, inputting grades and possibly selecting a value for q, as will be further detailed below.

Exemplary embodiments of the present invention relate to a large family of computer-based methods that may generically be called the qualified-majority judgement.

Detailed mathematical statements relating to exemplary embodiments of the present invention are set forth in the article written by the inventors, “A theory of measuring, electing and ranking,” Proceedings of the National Academy of Sciences USA 104 (May 2007) 8720-8725, which is incorporated by reference herein.

Depending upon the application or client problem (e.g., candidates for office, competitors in sports, entities such as goods, institutions services, measurements, . . . ), a common global language of evaluation is chosen.

The choice may be made for example by a consulting engineer who fully understands the qualified-majority judgement and the client who fully understands the problem or specific application.

Such common languages may already exist in many applications (such as diving wines, skating, measurement): they may be numbers, words, phrases or other symbols.

A user may be prompted by the computer system to select the common global language depending on the application.

The language comprises an ordered set of evaluations, meaning: if x, y and z are any components of the language and x is better than y is written x>y, then x>y and y>z imply x>z. The language may contain a finite or an infinite number of words: a finite number is usually preferable.

Each method may be characterized by a parameter, the degree of qualification, q^{±}, where q is a real number between 0 and 1 and may be modified by a superscript which is either a plus (+) or a (−) that determines a type of calculation.

The degree of qualification 0.5⁺ specifies all embodiment referred to as the majority judgement.

The method may comprise selecting a degree of qualifications q^{±}. The user may be prompted by the computer system to enter a value for q or the value may be set automatically after the user has selected an application.

Depending again on the client problem, the degree of qualifications q^{±} may be chosen for the problem after discussions between the consulting engineer and the client.

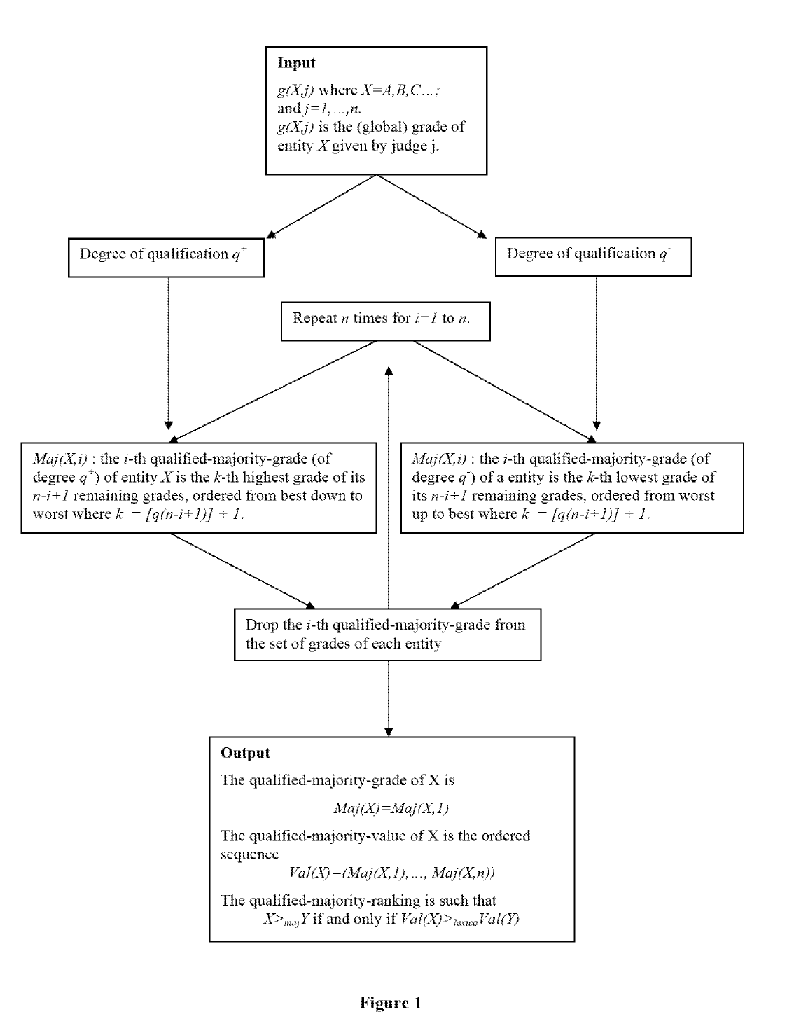

Some exemplary embodiments will now be described with reference made to FIG. 1. These embodiments relate to a “basic one-criterion procedure” and deal with the problem when each entity is evaluated by the judges according to a single “global” criterion using one common language of evaluation.

It may apply inter alia to situations where either (1) each of the individual judges appreciates and integrates all of the characteristics or attributes that contribute to establishing the merit or measure of an entity or (2) there is no one known or generally accepted rule which associates a global evaluation to each set of evaluations of the characteristics or attributes of an entity.

Every judge or voter may evaluate each entity by assigning him, her or it a grade in the common global language. Thus a vector or list of evaluations may be assigned each entity.

Suppose there are n judges, so each entity is assigned n grades. Let k=[qn]+1 (where [x] is the integer part of the number x, so that, for example, [8.73]=8 and [16.11]=16). The qualified-majority-grade of degree q⁺ of a entity is the k-th highest of his, her or its set of grades: when the grades are listed from best down to worst, it is the k-th of the list.

The qualified-majority-ranking of degree q⁺ lists the entities in order from highest-placed to last-placed.

It may be obtained as follows.

If an entity A has a higher qualified-majority-grade than an entity B, then A is ranked higher than B, written A>ₘₐⱼB.

If entities A anti B have the same qualified-majority grade go call it the “first qualified-majority grade,” and drop one grade g from both of their sets of grades. Find the qualified-majority-grade of the n−1 grades that remain of each entity, and call them their “second qualified-majority grades.” If one is higher than the other then that entity is ranked higher. If they are the same, repeat the procedure. In general the “i-th qualified-majority-grade” of an entity is the qualified-majority-grade after the first i−1 qualified-majority-grades have been dropped.

An entity's qualified-majority-value of degree q⁺ is a sequence of n grades, from his, her or its first to last qualified-majority grades.

A may be ranked higher than B, written A>ₘₐⱼ B, if A's qualified-majority-value is lexicographically greater than B's: that is, the sequences are ordered according to the first grade where they differ. Any one entity is necessarily ranked ahead or behind any other entity unless both entities have identical sets of grades (this is assuredly not the case for other methods of ranking, unless arbitrary, ad hoc rules are invoked). The first grade of the sequence is the entity's qualified-majority-grade, so the qualified-majority-values determine both outputs.

### Example 1

music competition, degree of qualification 0.5⁺ (the majority judgement). The global language is taken to be the set of ten integers {0, 3, 5, 6, . . . , 11, 13} (the numbers 1, 2, 4 and 12 are “missing,” as is done in Denmark's schools), with higher numbers designating better performances. There are nine judges, so nine grades: n=9, so k=[9×0.5]+=5. There are four entities: A, B, C, and D. The input is:

| Judge | A | B | C | D |
|---|---|---|---|---|
| 1 | 13 | 09 | 07 | 08 |
| 2 | 10 | 09 | 13 | 05 |
| 3 | 09 | 08 | 11 | 13 |
| 4 | 10 | 11 | 09 | 08 |
| 5 | 05 | 10 | 09 | 09 |
| 6 | 13 | 08 | 00 | 03 |
| 7 | 11 | 07 | 10 | 13 |
| 8 | 10 | 11 | 09 | 08 |
| 9 | 10 | 11 | 11 | 07 |

Thus, for example, judge 1 gives A a grade of 13, and D a grade of 8. From highest to lowest the grades of the entities are:

| A | B | C | D |
|---|---|---|---|
| 13 | 11 | 13 | 13 |
| 13 | 11 | 11 | 13 |
| 11 | 11 | 11 | 09 |
| 10 | 10 | 10 | 08 |
| 10 | 09 | 09 | 08 |
| 10 | 09 | 09 | 08 |
| 10 | 08 | 09 | 07 |
| 09 | 08 | 07 | 05 |
| 05 | 07 | 00 | 03 |

Since k=5, the qualified-majority-grades (in this case, the majority-grades since q=0.5⁺) are the fifth highest (in bold), thus: 10 for A, 9 for B and C, 8 for D. Their respective qualified-majority-values (in this case, their majority-values) are:
A: 10,10,10,10,11,09,13,05,13
B: 09,09,10,08,11,08,11,07,11
C: 09,09,10,09,11,07,11,00,13
D: 08,08,08,07,09,05,13,03,13

The qualified-majority-values are obtained as follows. The first numbers are the first-majority-grades. Dropping them leaves 8 grades, so the “new” k=[8×0.5]+1=5, and the second-majority-grades are the 5^{th} in the new list (or the 6^{th} in the old list). Dropping them leaves 7 grades, so the “new” k=[7×0.5]+1=4- and the third-majority-grades are the 4^{th} in the new list (also the 4^{th} in the old list). Dropping them leaves 6 grades, so the “new” k=[6×0.5]+1=4, and the fourth-majority-grades are the 4^{th} in the new list (or the 7^{th} in the old list). This process is repeated to the end. Therefore, the qualified-majority-ran-king (in this case, the majority-ranking) is

A>ₘₐⱼC>ₘₐⱼB>ₘₐⱼD.

since the sequences are ordered according to the first grade where they differ.

### Example 2

the same as example 1, but degree of qualification 0.2⁺. Since n=9, k=[9×0.2]+1=2, so the qualified-majority-grades are the second highest: 13 for A and D, 11 for B and C. Their respective qualified-majority-values are:
A: 13,11,10,10,10,13,10,09,05
B: 11,11,10,09,09,11,08,08,07
C: 11,11,10,09,09,13,09,07,00
D: 13,09,08,08,08,13,07,05,03

Therefore, the qualified-majority-ranking is

A>ₘₐⱼD>ₘₐⱼC>ₘₐⱼB,

since the sequences are ordered according to the first grade where they differ.

### Example 3

wine competition, degree of qualification 0.5⁺(the majority judgement). The global language is taken to be the set of words (from best to worst): excellent, very good, good, passable, poor, bad. There are five judges, so five grades: n=5, so k=[5×0.5]+1=3. There are three wines, Anjou, Beaujolais and Côtes-du-Rhône. The input gives the following grades, from highest to lowest:

| Anjou | Beaujolais | Côtes-du-Rhône |
|---|---|---|
| Very good | Excellent | Excellent |
| Very good | Very good | Excellent |
| Good | Good | Good |
| Good | Good | Passable |
| Passable | Poor | Poor |

Since k=3, the majority-grades are the third highest (in bold): each is good. Their respective majority-values are:
Anjou: Good, Good, Very good, Passable, Very good
Beaujolais: Good, Good, Very good, Poor, Excellent
Côtes-du-Rhône: Good, Passable, Excellent, Poor, Excellent
   Therefore, the majority-ranking is

Anjou>ₘₐⱼBeaujolais>ₘₐⱼCôtes-du-Rhône,

since the sequences are ordered according to the first grade where they differ. Internal regulations may use the majority-grades, -rankings and -values to classify wines as gold, silver, or bronze medallists.

Reference is now made to the qualified majority procedure q⁻.

When there are n judges, each entity is assigned n grades. Let k=[qn]+1, as before. The qualified-majority-grade of degree q⁻ of an entity is the k-th lowest of his, her or its set of grades: when the grades are listed from worst up to best, it is the k-th of the list (q⁻ is the “mirror image” of q⁺).

The procedure q⁻ gives the grade g when at least 100 q % of the grades are g or lower whereas the procedure q⁺ gives the grade g when at least 100 q % of the grades are g or higher.

The qualified-majority-ranking of degree q⁻ lists them in order from highest-placed to last-placed.

It may be obtained as follows. If an entity A has a higher qualified-majority-grade than an entity B, then A is ranked higher than B, written A>ₘₐⱼB. If entities A and B have the same qualified-majority grade g, call it the “first qualified-majority grade,” and drop one grade g from both of their sets of grades. Find the qualified-majority-grade of the n−1 grades that remain of each entity, and call them their “second qualified-majority grades.” If one is higher than the other then that entity is ranked higher. If they are the same, repeat the procedure. In general, the “i-th qualified-majority-grade” of an entity is the qualified-majority-grade after the first i−1 qualified-majority-grades have been dropped.

All entity's qualified-majority-value of degree q⁻ is a sequence of n grades, from his, her or its first to last qualified-majority grades. A is ranked higher than B, written A>ₘₐⱼB, if A's qualified-majority-value is lexicographically greater than B's: that is, the sequences are ordered according to the first grade where they differ. Any one entity is necessarily ranked ahead or behind any other entity unless both entities have identical sets of grades (this is assuredly not the case for other methods of ranking, unless arbitrary, ad hoc rules are invoked). The first grade of the sequence is the entity's qualified-majority-grade, so the qualified-majority-values determine both outputs.

### Example 4

the same as examples 1 and 2, but degree of qualification 0.2⁻. Since n=9, k=[9×0.2]+1=2, so the qualified-majority-grades are the second lowest: 9 for A, 8 for B, 7 for C and 5 for D. Their respective qualified-majority-values are:
A: 09,10,10,10,10,05,11,13,13
B: 08,08,09,09,10,07,11,11,11
C: 07,09,09,09,10,00,11,11,13
D: 05,07,08,08,08,03,09,13,13
   Therefore, the qualified-majority-ranking is

A>ₘₐⱼB>ₘₐⱼC>ₘₐⱼD.

### Example 5

the same as example 3, but degree of qualification 0.5⁻. Since k=3, the qualified-majority-grades are the third from the bottom (in bold): each is good, as before. However their respective qualified-majority-values are:
Anjou: Good, Very good, Good, Very good, Passable
Beaujolais: Good, Very good, Good, Excellent, Poor
Côtes-du-Rhône: Good, Excellent, Passable, Excellent, Poor.
   Therefore, the qualified-majority-ranking is different than that in example 3:

Côtes-du-Rhône>ₘₐⱼBeaujolais>ₘₐⱼAnjou.

### Example 6

blood pressure. The majority-grade and -ranking may be important for physical measurement as well, such as measuring blood pressure. With the usual auscultatory technique an inflatable cuff is wrapped around a person's arm, inflated until the artery is occluded, then the air is slowly released, reducing the pressure, until the blood begins to flow with a whooshing sound—the first “Korotkoff sounds”—that signals the systolic or highest pressure in the cardiac cycle, then continues to make turbulent sounds when the flow remains constricted, until there is no noise—the fifth “Korotkoft sounds” that signals the diastolic or lowest pressure in the cycle. The unit is millimeters of mercury (mm Hg), a typical healthy measurement is 120/80 (systolic/diastolic).

However, within minutes there may be very wide fluctuations in these measures—variations as large as 40 or more in systolic pressure—that may relate to excitement, apprehension or other exterior influences. Medical practice takes the average of the measurements, whose value is most highly influenced by the extreme readings. For example, two patients—or the same patient on different days—might have five successive readings in five minutes of: (181, 148, 141, 137, 139) for the first, and (158, 138, 153, 123, 147) for the second. The first's average is 149.27 the second's average is 143.8, indicating that the first has the higher systolic pressure. The majority judgement concludes the contrary: the first's “majority-systolic pressure” is 141 the second's is 147. The finding may have important medical significance when the readings concern one patient or when they are used to evaluate the states of health of different patients.

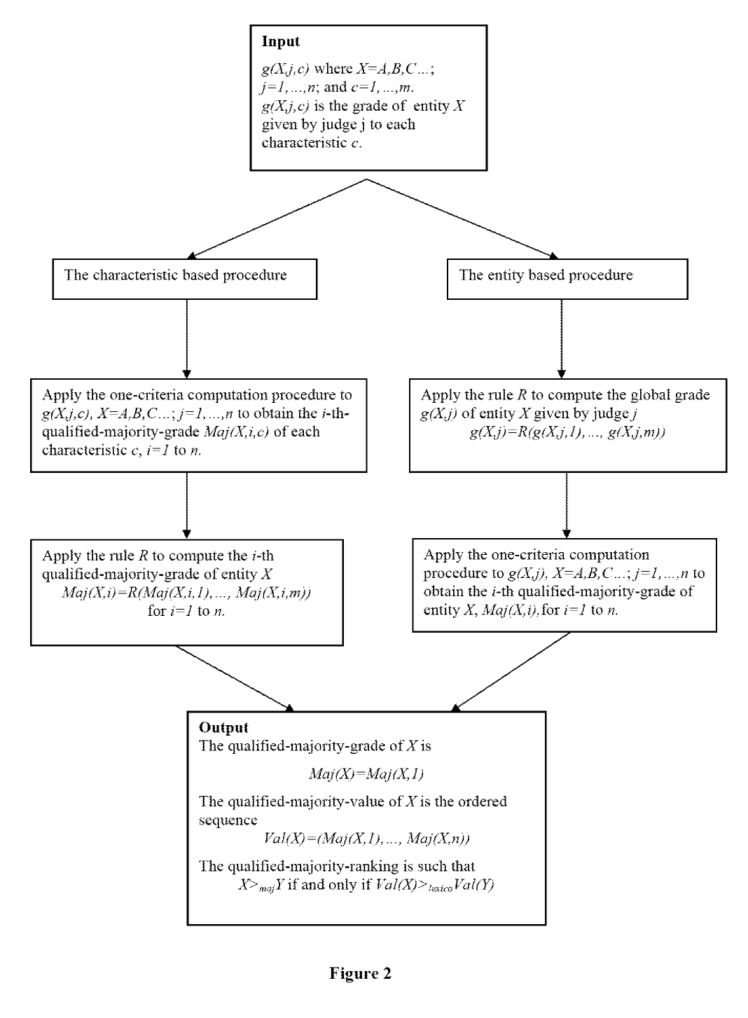

Further exemplary embodiments are described with reference to FIG. 2 and are “general multi-criteria procedures” and deal with the problem when each entity is evaluated by the judges, according to a set of criteria applied to each of the characteristics or attributes that contribute to establishing the merit or measure of the entity. It may apply to situations where there is a known or generally accepted rule which associates a global evaluation to each set of evaluations of the characteristics or attributes of an entity. It is recommended when either (1) individual judges are deemed not to have the competence to integrate for themselves their appreciations of all of the characteristics or attributes that contribute to establishing the overall merit or measure of an entity or (2) the task of so doing is too difficult even for expert judges.

These embodiments may comprise selecting characteristics and sub languages. In some applications judges may not be able or may not have the competence to directly assign a global evaluation to each entity. Instead, a global evaluation may be the result of evaluating separately each of several distinct characteristics or attributes of the entities.

Depending upon the characteristics or attributes of importance to the application or client problem, a common (sub)-language of evaluation may be chosen for each.

In many cases a same common language may be used for each characteristic or attribute; in others, different languages may be used. This choice may be made by a consulting engineer who fully understands the qualified-majority judgement and the client who full understands the problem or specific application.

Exemplary embodiments of the present invention may comprise defining, a rule R associating a global evaluation to every set of evaluations of the characteristics. The rule R that associates a global evaluation to the sub-evaluations may be a mathematical function that may be determined by a consulting engineer and the client.

The method may comprise selecting the associating rule R among predefined rules. The user may be prompted by the computer system to select the rule R.

The rule R may take many forms. When the words of the sub-languages are numbers, the global evaluation may be the sum, the average, a weighted-sum or a weighted-average of a sub-evaluations.

When the words of the sub-languages are symbols or words, the rule R may be defined otherwise.

Every judge or voter may evaluate every characteristic or attribute of each entity in the sub-language of that characteristic.

Thus a matrix or table of evaluations may be assigned to each entity: each line of the matrix or table corresponds to a characteristic, each column to a judge, and their intersection contains the evaluation of that characteristic by that judge (in the sub-language of that characteristic).

Depending on the client problem and the characteristics or attributes, one of two different types of computation may be performed.
The entity-based procedure: (i) The rule R determines the global evaluation of each entity by each judge as a function of the evaluations of the entity's characteristics or attributes. This gives each judge's “global grade” to each entity. (2) The qualified-majority-values of the global grades determine the qualified-majority-grades and the qualified-majority-ranking.
The characteristics-based procedure: (1) The qualified-majority-values of the characteristics of each entity are determined (the degrees of qualification may differ). (2) The rule R determines the i-th qualified-majority-grade of a entity as a function of the i-th qualified-majority grades of the entity's characteristics (from i=1 to 1, where n is the number of judges). The sequence of the i-th qualified-majority-grades of an entity from i=1 to n is the entity's qualified-majority-value, and so determines the qualified-majority-grades and the qualified-majority-ranking.

### Example 7

wine competition, degree of qualification 0.5⁺ (the majority judgement) globally and also for each characteristic. This example is deliberately simple and unrealistic. It is given simply to give a clear explanation of the two procedures.

Assume three judges; two characteristics, taste and aroma; and two wines, Bourgueil and Chinon. For each characteristic or attribute, the language is the same: excellent, very good, good, passable, poor; bad. The input is:

| | Judge 1: | | Judge 2: | | Judge 3: | |
|---|---|---|---|---|---|---|
| | Taste | Aroma | Taste | Aroma | Taste | Aroma |
| Bourgueil | Good | Excellent | Very good | Good | Poor | Good |
| Chinon | Very | Good | Poor | Good | Passable | Very |
| | good | | | | | good |

The rule R is defined as follows. First, it assigns numbers to each word of the language: excellent: 9, very good: 7, good: 6, passable: 4, poor: 2, bad: 0. Then, the rule R sums twice the number assigned to taste and the number given aroma to obtain the “global-grade” of each wine.

The entity-based procedure first determines the global evaluation of each entity by each judge. Thus, for example, judge 1 assigns (2×taste)+(aroma)=(2×6)+9=12+9=21 to Bourgueil. This yields:

| | Judge 1 | Judge 2 | Judge 3 |
|---|---|---|---|
| Bourgueil | 21 | 20 | 10 |
| Chinon | 20 | 10 | 15 |

Next, it computes the wines' majority-values:
Bourgueil: 20, 10, 21
Chinon: 15, 10, 20
   So Bourgueil's majority-grade is 20, Chinon's is 15, and the majority-ranking is Bourgueil>ₘₐⱼChinon.

The characteristics-based procedure first determines the majority-values of the characteristics of each entity:

| | |
|---|---|
| Bourgueil: | Taste: Good, Poor, Very good |
| | Aroma: Good, Good, Excellent |

| | |
|---|---|
| Chinon: | Taste: Passable, Poor, Very good |
| | Aroma: Good, Good, Very good |

Next, it uses the same rule R to determine the i-th qualified-majority-grade of each entity by adding twice the i-th qualified-majority-grade of taste to the i-th qualified-majority-grade of aroma. Thus, for example, Bourgueil's 1^{st}-majority-value is (2×taste)+(aroma)=(6×2)+6=12+6=18 and its 2^{nd}-majority-value is (2×taste)+(aroma)=(2×2)+6=4+6=10. The wine's majority-values are:
Bourgueil: 18, 10, 23
Chinon: 14, 10, 21

So Bourgueil's majority-grade is 18 and Chinon's is 14, and the majority-ranking is Bourgueil>ₘₐⱼChinon.

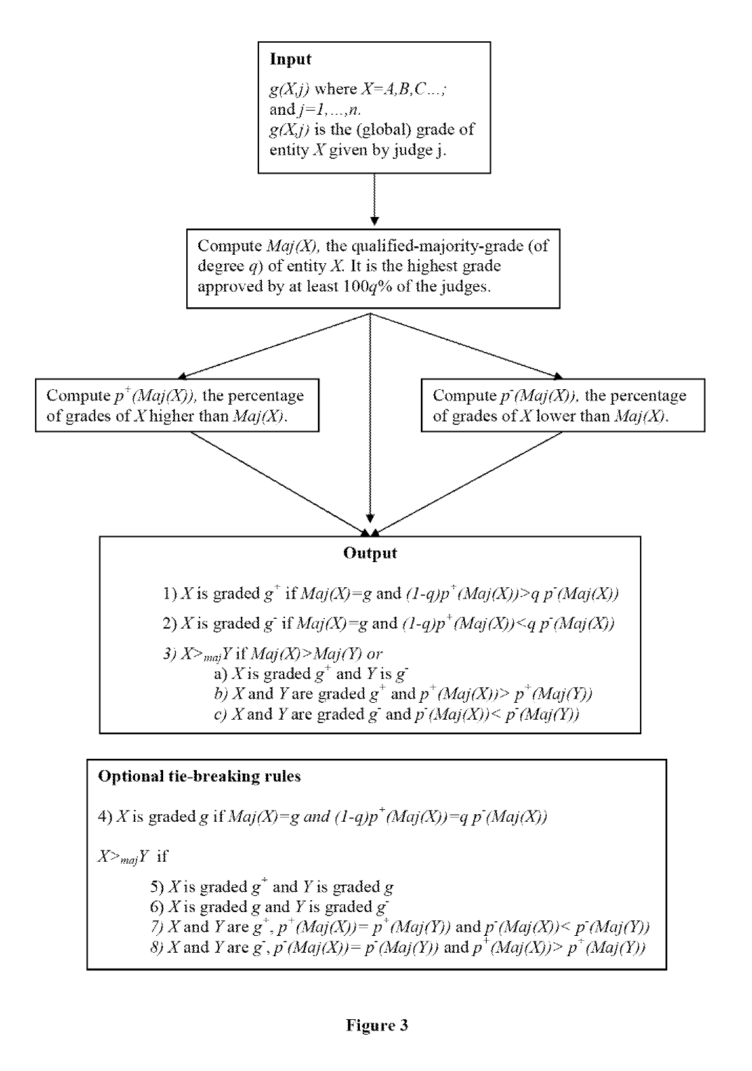

A further exemplary embodiment will be described with reference to FIG. 3. This embodiment is a “simplified procedure” and may be applied to any problem but is especially recommended for situations with many judges (hundreds to millions) and a language of evaluation of relatively few words (or levels); it may be used in voting when there are many voters.

When there are hundreds to millions of judges or voters, the global language preferably contains a relatively small number of words to assure that their meanings are understood in the same way by all the judges (or voters).

In such applications the qualified-majority judgement for the degrees q⁺ and (1−q)⁻ will be one and the same. However, the simplified procedure may be applied to any problem, though it may declare certain entities “tied” whereas they are not “tied” using, the basic procedure.

The simplified qualified-majority-grade of degree q⁺ of an entity is the grade g such that at least 100 q % of the grades are g or higher.

The simplified qualified-majority-ranking of degree q⁺ of the entities lists them in order from highest-placed to last-placed.

If entity A has a higher qualified-majority-grade than an entity B, then A is ranked higher than B, written A>ₘₐⱼB. Suppose Two entities A and B that have the same qualified-majority-grade g may be distinguished as follows.

Consider an entity with qualified-majority-grade g. Suppose his, her or its percentage of grades higher than is g is p⁺(g) and lower than g is p⁻(g). Then the entity's modified-majority-grade is g⁺ if (1−q)p⁺(g)>qp⁻(g) and it is g⁻ if (1−q)p⁻(g)<qp⁻(g). An entity with a grade g⁺ is ranked ahead of a entity with a grade g⁻.

When two entities have the same modified-majority-grade they may be distinguished as follows. Of two entities with a g⁺, the one having the greater percentage of grades higher than g is ranked ahead of the other: of two entities with a g⁻, the one having the greater percentage of grades lower than g is ranked behind the other. A simpler, but more manipulable rule to distinguish two entities that have a (qualified-majority-grade of g is to rank the one with the greater (1−q)p⁺(g)−qp⁻(g) higher.

The simplified qualified-majority grade of degree (1−q)⁻ of an entity is the grade g such that at least 100(I−q) % of the grades are g or lower.

The simplified qualified-majority-ranking of degree (1−q)⁻ of the entities lists them in order from highest-placed to last-placed in the same manner as the simplified qualified-majority-ranking of degree q⁺.

### Example 8

French presidential elections, first-round, 2007, qualified-majority judgement of degree 0.5 with many judges (so the majority judgement). Since q=0.5, this is the majority judgement. The majority-grade of a candidate is the highest grade g approved by at least 50% of the voters (and also the lowest grade approved by at least 50% of the voters). For example (see the inputs below), Vo's majority-grade is acceptable because 53.4%=2.9%+9.3%+17.5%+23.7% of the voters believe Vo merits a least an acceptable (and also a majority of 70.3%=23.7%+26.1%+16.2%+4.3% believe Vo merits at most an acceptable). Vo's grade is an acceptable—because: the percentage of grades higher than acceptable is p⁺(acceptable)=2.9+9.3+17.5=29.8%, the percentage of grades lower than acceptable is p⁻ (acceptable)=26.1+16.2+4.3=46.6%, and so (1−q)p⁺(g)=(1−0.5)×29.8<0.5×46.6=qp⁻(g). (Since q=0.5 and the procedure is the majority judgement, this may be said more intuitively: the percentage of grades higher than acceptable is smaller than the percentage of grades lower than acceptable.) Voters in this experiment were specifically informed that giving no grade to a candidate meant giving the candidate the grade To reject.

The inputs of an experiment in three voting precincts were:

| | | Very | | | | To | No grade |
|---|---|---|---|---|---|---|---|
| Candidates | Excellent | good | Good | Acceptable | Poor | reject | given |
| Ba | 13.6% | 30.7% | 25.1% | 14.8% | 8.4% | 4.5% | 2.9% |
| Ro | 16.7% | 22.7% | 19.1% | 16.8% | 12.2% | 10.8% | 1.8% |
| Sa | 19.1% | 19.8% | 14.3% | 11.5% | 7.1% | 26.5% | 1.7% |
| Vo | 2.9% | 9.3% | 17.5% | 23.7% | 26.1% | 16.2% | 4.3% |
| Be | 4.1% | 9.9% | 16.3% | 16.0% | 22.6% | 27.9% | 3.2% |
| Bu | 2.5% | 7.6% | 12.5% | 20.6% | 26.4% | 26.1% | 4.3% |
| Bo | 1.5% | 6.0% | 11.4% | 16.0% | 25.7% | 35.3% | 4.2% |
| La | 2.1% | 5.3% | 10.2% | 16.6% | 25.9% | 34.8% | 5.3% |
| Ni | 0.3% | 1.8% | 5.3% | 11.0% | 26.7% | 47.8% | 7.2% |
| Vi | 2.4% | 6.4% | 8.7% | 11.3% | 15.8% | 51.2% | 4.3% |
| Sc | 0.5% | 1.0% | 3.9% | 9.5% | 24.9% | 54.6% | 5.8% |
| LP | 3.0% | 4.6% | 6.2% | 6.5% | 5.4% | 71.7% | 2.7% |

The majority-grades and -ranking for these inputs are given in the following table together with the actual votes of the first round of voting (where each voter can vote for at most one candidate) and the actual order of finish in the same three voting precincts. Notice that the orders are completely different.

| | | % higher | | | | |
|---|---|---|---|---|---|---|
| | | than | | % lower | % | Actual |
| Majority- | | majority- | Majority- | than | actual | order |
| Ranking | | grade | grade | gmajority-rade | votes | of finish |
| 1 | Ba | 44.3% | Good+ | 30.6% | 25.5% | 3 |
| 2 | R | 39.4% | Good− | 41.5% | 29.9% | 1 |
| 3 | Sa | 38.9% | Good− | 46.9% | 29.0% | 2 |
| 4 | Vo | 29.8% | Acceptable− | 46.6% | 1.7% | 7 |
| 5 | Be | 46.3% | Poor+ | 31.2% | 2.5% | 5 |
| 6 | Bu | 43.2% | Poor+ | 30.5% | 1.4% | 8 |
| 7 | Bo | 34.9% | Poor− | 39.4% | 0.9% | 9 |
| 8 | La | 34.2% | Poor− | 40.0% | 0.8% | 10 |
| 9 | N | 45.0% | To reject | — | 0.3% | 11 |
| 10 | Vi | 44.5% | To reject | — | 1.9% | 6 |
| 11 | S | 39.7% | To reject | — | 0.2% | 12 |
| 12 | LP | 25.7% | To reject | — | 5.9% | 4 |

### Juries of Different Sizes.

Most wine competitions have juries of five members. When there are many competing wines, there are many separate juries. Sometimes a member may be absent (sick or otherwise unable to participate). Yet wines evaluated by different juries must be ranked.

In such cases—that is, when there are juries containing a small number of experts—the qualified-majority judgement may, be used as follows.

The qualified-majority-grades may be determined within each jury, as before. The qualified-majority-ranking between two wines (or entities) that have different juries of the same size is exactly the same as before. Suppose then that two wines (or entities) A and B have been evaluated by juries of different sizes, say B has the smaller jury. Then adjoin to B's set of grades its, her or his qualified-majority-grade as many times as is required to give the set the same number of grades as has A, and apply the qualified-majority-ranking as before. As a consequence, B's qualified-majority-value is modified by adding B's qualified-majority-grade that many times in the first places.

In the case of an electorate of hundreds to millions, some voters may not assign grades to some candidates (see example 6 where depending upon the candidate in question, the percentages of such voters vary between 1.7% and 7.2%). Not assigning a grade may, in this application, be interpreted as the worst grade, but this fact may be made known to every voter (in the experiment of example 6, this fact was stated on every ballot); or grades may be completed by adjoining the qualified-majority-grade as above; or they may completed by adjoining any one fixed grade as above; or only percentages may be used.

### Example 9

wine competition, degree of qualification 0.5⁺ (the majority judgement), juries of different sizes. Assume the global language of example 3 and inputs that yield the following grades in two separate juries:

Jury of size 5

| Margaux | Pauillac | Graves |
|---|---|---|
| Very good | Excellent | Excellent |
| Very good | Very good | Very good |
| Very good | Very good | Very good |
| Good | Good | Very good |
| Good | Good | Good |

Jury of size 4

| St. Emilion | St. Estèphe |
|---|---|
| Very good | Excellent |
| Very good | Very good |
| Very good | Very good |
| Good | Passable |

The majority-grades are given in bold. To obtain the majority-ranking among all of the wines, adjoin to the set of each of the wines of the smaller jury its majority-grade to obtain:

Jury of size 5

| Margaux | Pauillac | Graves |
|---|---|---|
| Very good | Excellent | Excellent |
| Very good | Very good | Very good |
| Very good | Very good | Very good |
| Good | Good | Very good |
| Good | Good | Good |

Jury of size 4 + maj.-grade

| St. Emilion | St. Estèphe |
|---|---|
| Very good | Excellent |
| Very good | Very good |
| Very good | Very good |
| Very good | Very good |
| Good | Passable |

The majority-grades are given in bold and are all the same. The majority-values are:
Margaux: Very good, Good, Very good, Good, Very good
Pauillac: Very good, Good, Very good, Good, Excellent
Graves: Very good, Very good, Very good, Good, Excellent
St. Emilion: Very good, Very good Very good, Good, Very good
St. Estéphe: Very good, Very good, Very good, Passable, Excellent
   Therefore, the majority-ranking is:

Graves>ₘₐⱼSt. Emilion>ₘₐⱼSt. Estéphe>ₘₐⱼPauillac>ₘₐⱼMargaux

Other embodiments of the invention will be apparent to those skilled in the art from consideration of the specification and practice of the invention disclosed herein. It is intended that the specification and examples be considered as exemplary only.

1. A computer implemented method for at least one grading, measuring, classifying entities and/or ranking entities, and/or designating a winner among entities, with each entity assigned n grades of an ordered language of evaluation, where n is an integer greater than 1, the method comprising:
a) sorting the grades assigned each entity according to a first ordering rule to obtain a first list of ordered grades,
b) for i=1, . . . , n generating for each entity a second list of ordered grades from the first list by assigning an i^{th} grade of the first list to a place in the second list according to a second ordering rule,
c) at least one of assigning a first grade of an entity's second list to that entity, ranking the entities based on comparisons of the second lists, designating the winner among the entities as the one that is the first in the ranking, and classifying the entities based on the second lists.

2. The method of claim 1, wherein the entities are selected among persons, objects, services, institutions, companies, investment portfolios, measurements or legal entities.

3. The method of claim 1, wherein the grades are numerical values.

4. The method of claim 1, wherein the grades are non-numerical ordered attributes.

5. The method of claim 1, wherein the first ordering rule lists the grades from highest to lowest.

6. The method of claim 1, wherein the first ordering rule lists the grades from lowest to highest.

7. The method of claim 1, wherein for a given parameter q from 0 to less than 1, the second ordering rule comprises:
a) initializing a first current ordered list as the first list of ordered grades,
b) the i^{th} grade of the second list for i=1, . . . , n is the k^{th} grade of the i^{th} current ordered list, where k=[q(n−i+1)]+1, and the (i+1)^{th} current ordered list is obtained from the i^{th} ordered current list by dropping the grade just designated.

8. The method of claim 7, wherein q=0.5 and the first ordering rule lists the grades from highest to lowest.

9. The method of claim 1, wherein the comparisons of the second lists is lexicographic.

10. The method of claim 1, wherein when the entities have initially different numbers of grades and the entities that do not have as many grades as the other are assigned supplementary grades as many times as necessary so that all the entities have the same number of grades.

11. The method of claim 1, wherein when the entities have initially different numbers of grades, the first grade of the second list of each entity that does not have as many grades as the other is adjoined as many times as necessary so that all the entities have the same number of grades in their second lists, the adjoined grades being either all adjoined at the beginning of the second lists or all adjoined at the end of their second lists.

12. The method of claim 1, with each entity evaluated by a set of characteristics, each characteristic of each entity assigned grades, a rule that assigns an entity's grade to any set of the entity's characteristic grades, and the method is applied to the entity's grades.

13. The method of claim 1, with each entity evaluated by a set of characteristics, each characteristic of each entity assigned grades, the method of claim 1 being used to obtain a second ordered list of characteristic grades for each characteristic of each entity, and the i^{th} grade of the second list of grades of each entity is obtained with a rule that assigns a grade to the set of the entity's second ordered list of i^{th} characteristic grades.

14. A computer implemented method for either grading entities, and/or ranking entities, and/or classifying entities, and/or designating a Sinner among entities, with each entity assigned many grades of an ordered language of evaluations, the method comprising.
a) determining percentages of the different grades assigned to each entity,
b) determining, for any q between 0 and 1, a qualified-majority-grade g of each entity such that at least 100 q % of the entity's grades is g or higher,
c) ranking the entities, and designating the winner as the first in the ranking, according to the rule: an entity with a higher qualified-majority-grade than another is ranked higher; otherwise, a tie-breaking rule is used.

15. The method of claim 14, wherein the entities are selected among persons, objects, services, institutions, companies, investment portfolios, measurements, or legal entities.

16. The method of claim 14, wherein the grades are numerical values.

17. The method of claim 14, wherein the grades are non-numerical ordered attributes.

18. The method of claim 14, wherein q=0.5.

19. The method of claim 14, wherein ties in the ranking of entities are resolved by determining p⁺(g), the percentage of an entity's grades higher than g and p⁻(g) the percentage of the entity's grades lower than g, and of two entities with an equal qualified-majority-grade g, ranking higher the entity for which (1−q)p⁺(g)−qp⁻(g) is bigger.

20. The method of claim 14, wherein ties in the ranking of entities are resolved by determining p⁺(g) the percentage of the entity's grades higher than g and p⁻(g) the percentage of the entity's grades lower than g, and
assigning the entity a modified-majority-grade g⁺ if (1−q)p⁺(g)>qp⁻(g),
assigning the entity a modified-majority-grade g⁻ if (1−q)p⁺(g)<qp⁻(g),
an entity with a modified-majority-grade of g⁺ is ranked higher than one with a modified-majority-grade of g⁻,
between two entities with a modified-majority-grade of g⁺, the entity with the greater p⁺(g) is ranked higher,
between two entities with a modified-majority-grade of g⁻, the entity with the greater p⁻(g) is ranked lower,
otherwise a further tie-breaking rule is used.

21. The method of claim 20, wherein ties in the ranking of entities are resolved according to the rule:
assign the entity a modified-majority-grade g⁼ if (1−q)p⁺(g)=qp⁻(g),
an entity with a modified-majority-grade of g⁺ is ranked higher than one with a modified-majority-grade of g⁼,
an entity with a modified-majority-grade of g⁼ is ranked higher than one with a modified-majority-grade of g⁻,
between two entities with a modified-majority-grade of g⁺ and the same p⁺(g), the entity with the smaller p⁻(g) is ranked higher,
between two entities with a modified-majority-grade of g⁻ and the same p⁻(g), the entity with the greater p⁺(g) is ranked higher,
otherwise, a tie-breaking rule is used.

22. The method of claim 14, wherein b) is replaced by:
b) determining, for any q between 0 and 1, the qualified-majority-grade g of each entity, namely, g such that at least 100(1−q) % of the entity's grades is g or lower.

23. The method of claim 14, wherein when the entities have different numbers of grades, those that do not have the greatest number are assigned supplementary grades as many times as necessary so that all the entities have the same number of grades.

24. A computer system for at least one of grading, measuring, classifying entities and/or ranking entities, and/or designating a winner among entities, with each entity assigned n grades of an ordered language of evaluations, where n is an integer greater than 1, the system comprising processor means configured for:
a) sorting the grades assigned each entity according to a first ordering rule to obtain a first list of ordered grades,
b) generating for each entity a second list of ordered grades from the first list by assigning an i^{th} grade of the first list for i=1, . . . , n to a place in the second list according to a second ordering rule,
c) displaying a result, the result comprising at least one of assigning a first grade of an entity's second list to that entity, ranking the entities based on comparison of the second lists, designating the winner among the entities as the one that is the first in the ranking, and classifying the entities based on the second lists.
